(19) United States
(12) Patent Application Publication
(10) Pub. No.: US 2014/0004311 A1
(43) Pub. Date: Jan. 2, 2014

(54) Cookware Surface and Method for Forming Cookware Surface

(71) Applicant: Prakasa Alim, Surabaya (ID)

(72) Inventor: Prakasa Alim, Surabaya (ID)

(73) Assignee: PT MASPION, Surabaya (ID)

(21) Appl. No.: 13/537,948

(22) Filed: Jun. 29, 2012

(51) Int. Cl. B32B 3/10; B21C 23/24

(52) U.S. Cl. 428/172; 72/46

(57) ABSTRACT

A cookware surface comprises a corrugated surface. The corrugated surface is formed of a plurality of raised portions and a plurality of lower areas. The lower areas have a non-stick surface formed thereon, and the raised portions have a hard anodized finish formed thereon. The raised portions aid in preventing cooking utensils from rubbing off the non-stick surface of the lower areas. A method of forming a surface for cookware is disclosed comprising forging a predetermined pattern of corrugations on a surface of the cookware, applying a non-stick coating to the surface of the cookware, and removing the non-stick coating from the raised portions.

### TECHNICAL FIELD

The disclosure herein relates to the field of scratch resistant non-stick cookware surfaces and prolonging the life of non-stick cookware surfaces.

### BACKGROUND

A cookware surface is typically coated with a non-stick coating on its upper surface to prevent foodstuffs from sticking on the surface. However, the use of cooking utensils often scrape or rub off the coating, thereby exposing the base layer or body of the cookware.

### BRIEF SUMMARY

In one exemplary embodiment disclosed herein, a cookware surface comprises a corrugated surface. The corrugated surface is formed of a plurality of raised portions and a plurality of lower areas. The lower areas have a non-stick surface formed thereon, and the raised portions have an anodized finish formed thereon. The raised portions are formed flat, and the lower areas are also formed flat. The lower areas form a larger percentage surface area on the cookware surface than that of the raised portions. In particular, the raised portions comprise less than 20% of cookware surface of the area having the corrugated portion, and the lower areas form the remaining portion of the corrugated surface. The raised portions aid in preventing cooking utensils from rubbing off the non-stick surface of the lower areas. The raised portions provide adequate spacing such that the cooking utensils are prevented from contacting the lower areas having the non-stick surface. The tops of the plurality of raised portions are formed free from non-stick material and can be formed with an anodized finish to prevent the cooking utensils from scratching and exposing the base metal of the cookware.

In another exemplary embodiment, a method of forming a surface for cookware is disclosed comprising forging a predetermined pattern of corrugations on a surface of the cookware, applying a non-stick coating to the surface of the cookware, and removing the non-stick coating from the raised portions. The non-stick coating is removed from the raised portions by grinding the surface of the cookware. The surface of the raised portions is anodized to form an anodized finish on the raised portions.

### BRIEF DESCRIPTION OF THE DRAWINGS

The present disclosure is illustrated by way of example and not limited in the accompanying figures:

FIG. 1a shows a partial top view of an exemplary embodiment;

FIG. 1b shows a cross-sectional partial side view of the exemplary embodiment in FIG. 1a;

FIG. 1c shows a magnified view of the exemplary embodiment of FIG. 1a;

FIG. 1d shows a surface pattern in accordance with the embodiment shown in FIG. 1a;

FIG. 2 shows another exemplary surface pattern that can be applied to a cookware surface;

FIG. 3 shows another exemplary surface pattern that can be applied to a cookware surface;

FIG. 4 shows another exemplary surface pattern that can be applied to a cookware surface;

FIG. 5 shows another exemplary surface pattern that can be applied to a cookware surface;

FIG. 6 shows another exemplary surface pattern that can be applied to a cookware surface;

FIG. 7 shows another exemplary surface pattern that can be applied to a cookware surface;

FIG. 8 shows another exemplary surface pattern that can be applied to a cookware surface;

FIG. 9 shows another exemplary surface pattern that can be applied to a cookware surface;

FIG. 10 shows another exemplary surface pattern that can be applied to a cookware surface;

FIG. 11 shows another exemplary surface pattern that can be applied to a cookware surface;

FIG. 12 shows another exemplary surface pattern that can be applied to a cookware surface;

FIG. 13 shows another exemplary surface pattern that can be applied to a cookware surface;

FIG. 14 shows another exemplary surface pattern that can be applied to a cookware surface; and

FIG. 15 shows another exemplary surface pattern that can be applied to a cookware surface.

### DETAILED DESCRIPTION OF THE INVENTION

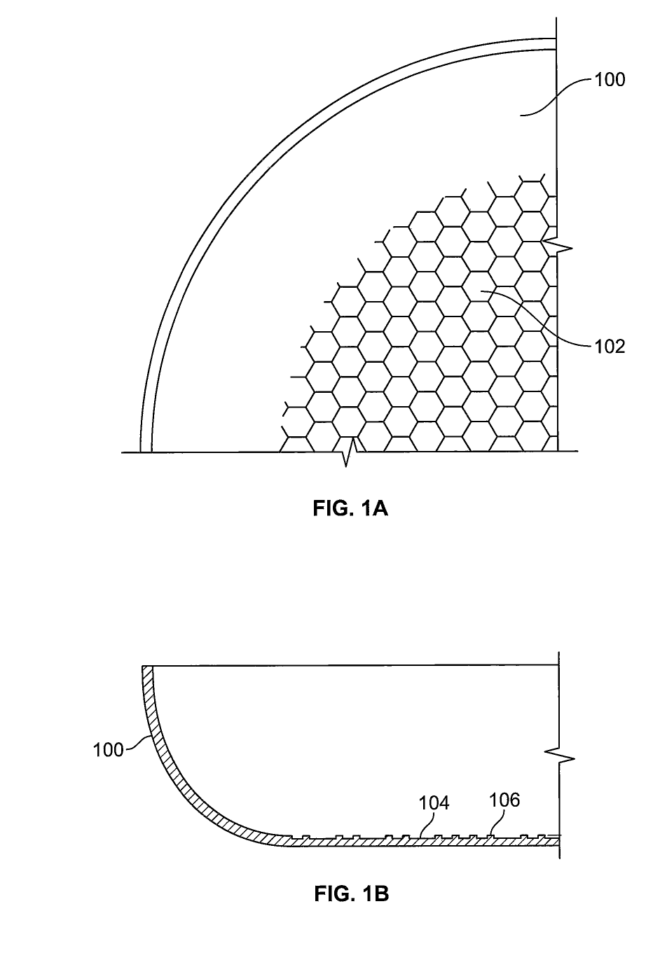

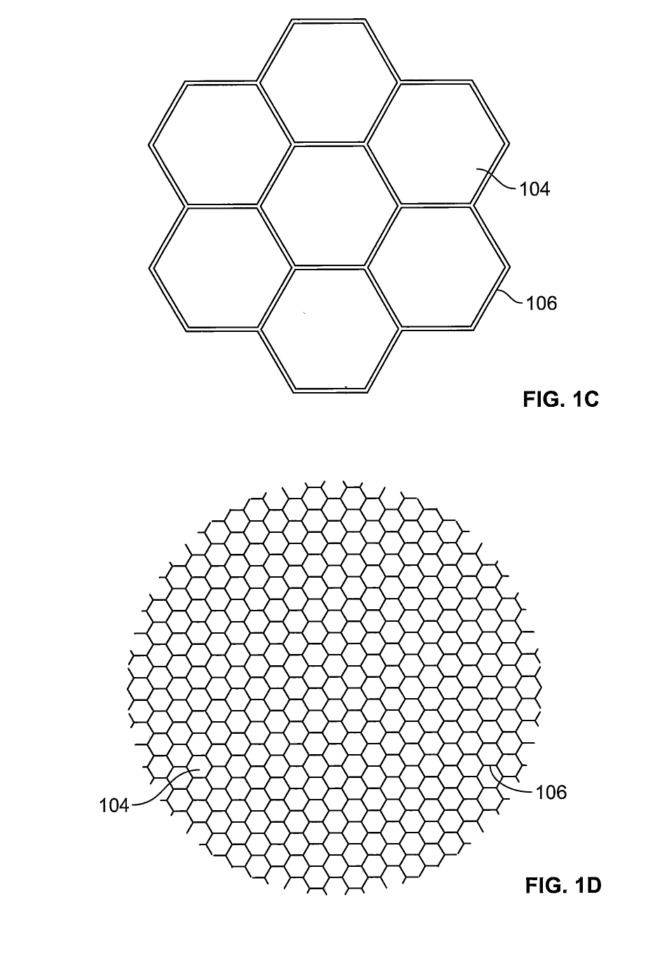

FIGS. 1a and 1b depict a partial view of a piece of cookware 100 having a surface 102 on the upper surface of the cookware 100. The surface 102 is corrugated with a plurality of raised portions 106. As depicted in FIGS. 1a, 1c, and 1d, the plurality of raised portions 106 can, for example, form a plurality of hexagons or a honeycomb-like structure. The lower areas 104 formed in between the raised portions 106 can form flat surfaces between the raised portions 106. The raised portions 106 and the lower surface areas 104 make up the upper surface 102 of the cookware 100. The raised portions 106 can occupy a smaller surface area when compared with the lower areas 104. The raised portions 106 form peaks, and the lower areas 104 form valleys. The plurality of raised portions 106 can be formed with a hard anodized finish on the uppermost surfaces, and the lower areas 104 can have a non-stick coating for preventing foodstuffs from sticking to the lower areas 104.

In one embodiment, the raised portions 106 can be formed flat on their uppermost top surface, and the lower areas 104 can also be formed with a flat surface. The raised portions 106 can be formed as a thin strip of material and can be formed with straight sides to form edges at a right angle. The peaks of the raised portions 106, however, can be formed both flat, sharp, or of combinations thereof. If the peaks are formed too sharp, however, the more likely the utensil will touch the lower areas 102 forming the non-stick surface during use meaning that the non-stick coating could be scratched and subsequently removed from the lower areas 104.

The anodized peaks or corrugated portions 106 will come in contact with cooking utensils first and provide for resistance against rubbing of utensils such that the non-stick material is maintained on the lower areas 104 of the surface 102. The lower areas 104 coated with non-stick coating provides for resistance to the foodstuffs sticking to the surface 102.

The raised portions 106 can be formed at an optimum height to provide the best non-stick properties of the cookware 100 and to prevent scratching to the cookware 100. For example, if the raised portions 106 are formed too short, the cooking utensil may still scratch the non-stick coating 104. However, if the raised portions 106 are formed too high, the cookware 100 may lose its non-stick performance because the food will only be able to rest and stick to the peaks of the raised portions 106.

Likewise, the spacing between the raised portions 106 can be formed at an optimum spacing to provide the best non-stick properties of the cookware and to prevent scratching of the lower surface areas 104. For example, because the spacing forming the lower areas 104 between the raised portions 106 is the only area which has non-stick coating on it, the larger the area 104, the less likely food will stick to the cookware surface 102. However, if the lower areas 104 make up too much of the surface area of the cookware surface 102, the cooking utensil may scratch the non-stick coating on the lower areas 104 during use and remove the nonstick coating from the lower areas 104.

The width, height, and percentage of the coverage on the cookware of the raised portions 106 can be defined based on the desired use of the particular cookware. In one exemplary embodiment, the width of the raised portions 106 is about less than 1 mm, the height of the raised portions is about less than 0.8 mm. In one exemplary embodiment the percentage area of the raised portions with an anodized finish covering the bottom corrugated surface of cookware is about less than 20%.

[30] The non-stick portion of the pan can be formed by the following steps. First, the raised portions 106 can be formed by forging or pressing a particular pattern on an upper surface 102 of the cookware 100. A non-stick coating can then be applied to the upper surface 102 of the cookware 100. The non-stick coating can then be removed from the raised portions 106 by way of surface grinding the upper surface 102 of the cookware 100. The grinding process of the raised portions 106 results in the peaks of the raised portions 106 to be formed flat. The cookware 100 raised portions 106 are then anodized to form a hard anodized finish on the raised portions 106.

As discussed above, during the manufacturing process the non-stick coating is intentionally removed from the peaks of raised portions 106. The raised portions 106 are then anodized, which provides increased scratch resistance on the upper surface 102 of the cookware 100. The lower areas 104 will remain coated with non-stick coating even during use since the raised portions 106 will help prevent the lower areas 104 from being scratched by a cooking utensil. This helps maintain the non-stick coating on the lower areas 104 to increase the life of the nonstick surface and reduce the likelihood that food becomes exposed to the base metal of the cookware 100.

The raised portions 106 can be formed of various configurations and patterns as shown in FIGS. 1a-15. The specific patterns formed by the raised portions 106 can vary for aesthetical purposes. The patterns of the raised portions 106 can be in many shapes, as long as the total area of the anodized portions are maintained in relation to the total surface area to provide the required non-stick performance while increasing the cookware's durability against scratches.

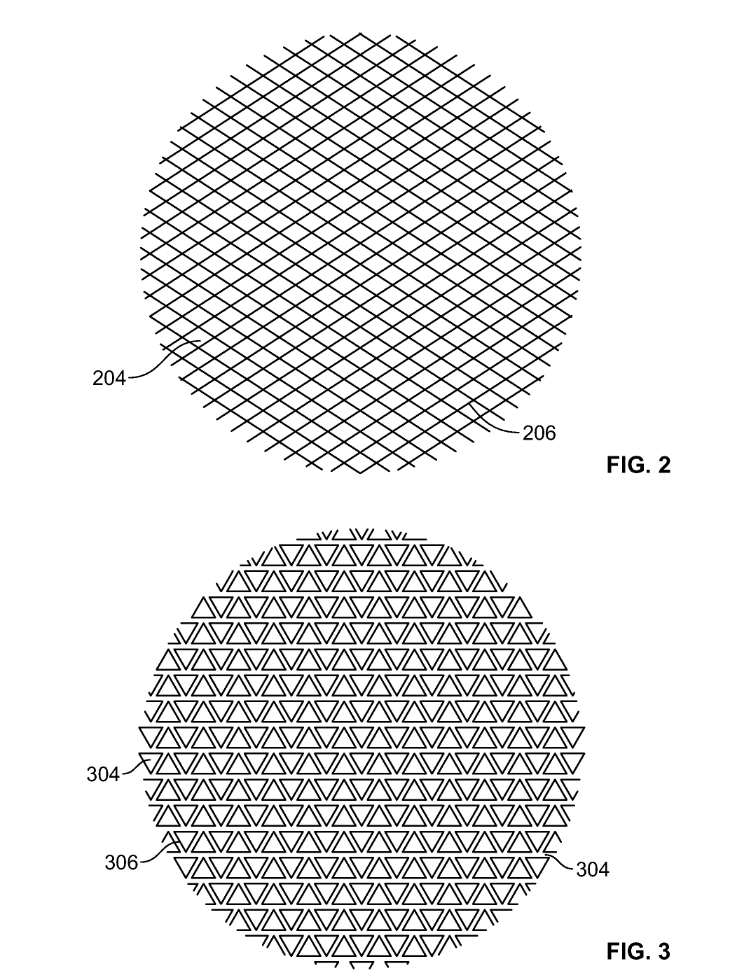

In another example, shown in FIG. 2, the raised portions 206 are formed in a diamond shaped configuration on the upper surface of a particular piece of cookware. Similar to the embodiment shown in FIGS. 1a-1d, the raised portions 206 can have a hard anodized finish and the lower areas 204 of cookware have a non-stick coating.

In another example, shown in FIG. 3, the raised portions 306 are formed in triangle shaped configurations on the upper surface of a particular piece of cookware. Similar to the embodiment shown in FIGS. 1a-1d, the raised portions 306 can have a hard anodized finish and a non-stick coating can be applied to the lower areas 304 of cookware.

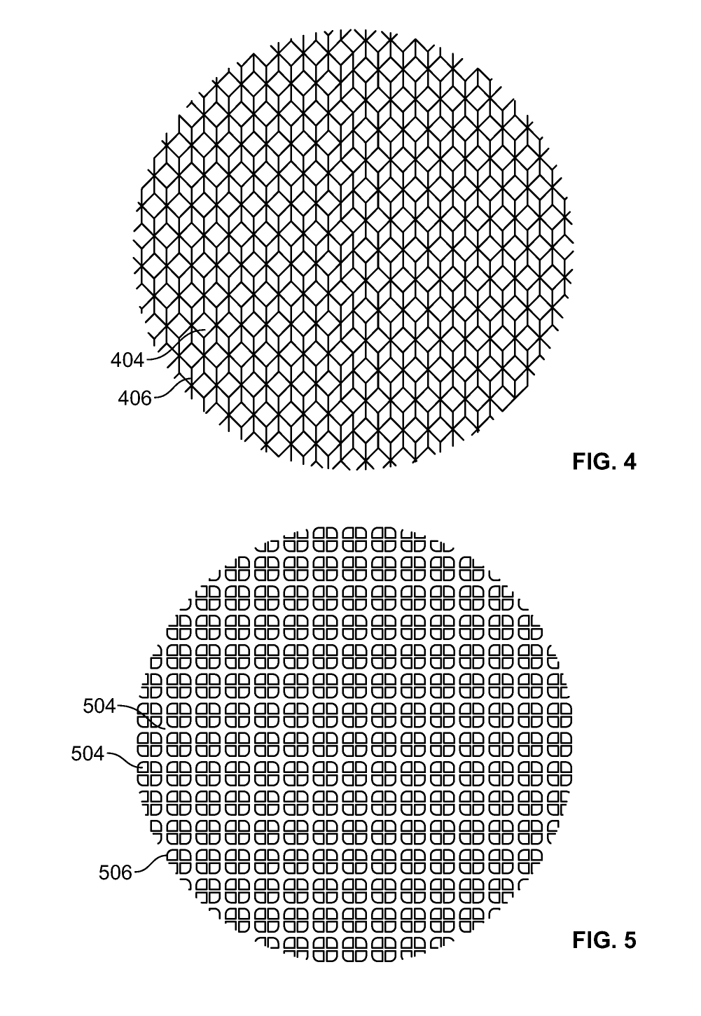

FIG. 4 depicts forming the raised portions 406 to form diamonds and rhombus shaped configurations on the upper surface of the cookware. Similar to the embodiment shown in FIGS. 1a-1d, a hard anodized finish can be applied the raised portions 406, and a non-stick coating can be applied to the lower areas 404 formed inside the raised portions 406.

FIG. 5 depicts forming the raised portions 506 to form fan shaped configurations on the upper surface of the cookware. The fan shaped configurations can be formed facing inward toward each other such that each vertex is positioned in close proximity to each other. This results in a cross-like shape is formed in between each cluster of four fan shapes. Similar to the embodiment shown in FIGS. 1a-1d, a hard anodized finish can be applied to the raised portions 506, and a non-stick coating can be applied to the lower areas 504 formed inside and outside of the raised portions 506.

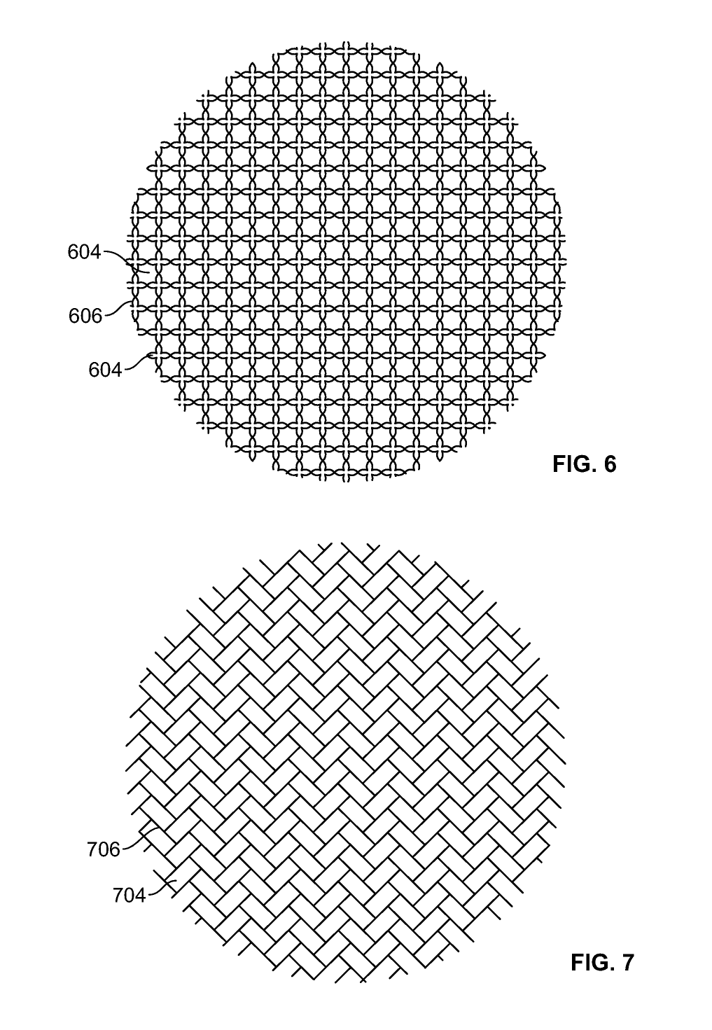

FIG. 6 depicts another embodiment of an exemplary cookware surface. In this embodiment the raised portions 606 form cross-like shapes having rounded portions and pointed ends on the upper surface of the cookware. The cross-like shapes can be formed such that the pointed ends intersect the pointed ends on the adjacent cross-shapes. Similar to the embodiment shown in FIGS. 1a-1d, the raised portions 606 can have a hard anodized finish, and a non-stick coating can be applied to the lower areas 604 of the cookware surface formed inside and outside of the cross-shapes.

FIG. 7 depicts another embodiment of an exemplary cookware surface. In this embodiment, the raised portions 706 form slanted rectangles on the upper surface of the cookware. The rectangles can be formed such that L-shapes are formed on the surface of the pan. Similar to the embodiment shown in FIGS. 1a-1d, the raised portions 706 can have a hard anodized finish applied to their surfaces, and a non-stick coating can be applied to the lower areas 704 of the cookware surface formed inside of the rectangles.

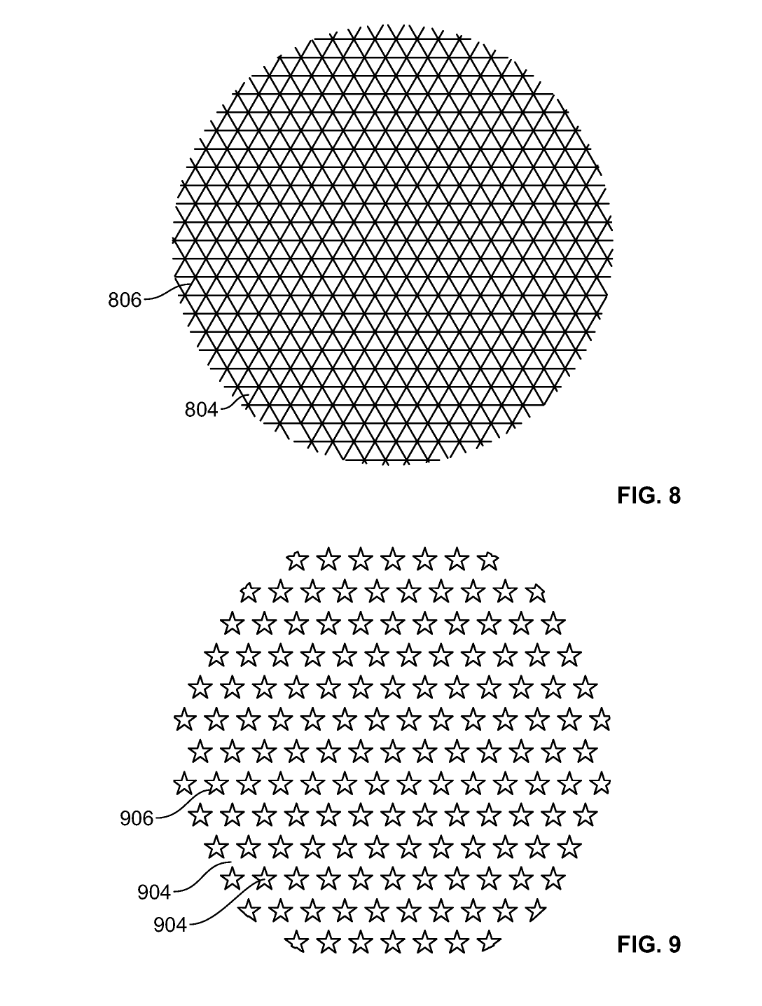

FIG. 8 depicts another exemplary embodiment of a cookware surface. In this embodiment, the raised portions 806 form equilateral triangles on the upper surface of the cookware. The triangles can be formed such that the sides of each triangle are shared with three adjacent triangles. Similar to the embodiment shown in FIGS. 1a-1d, the raised portions 806 can have a hard anodized finish applied to their surfaces, and a non-stick coating can be applied to the lower areas 804 of the cookware surface formed inside of the triangles.

FIG. 9 depicts another exemplary embodiment of a cookware surface. In this embodiment, the raised portions 906 form stars on the upper surface of a pan. The stars can be spaced equidistant from one another. Similar to the embodiment shown in FIGS. 1a-1d, the raised portions 906 can have a hard anodized finish applied to their surfaces, and a non-stick coating can be applied to the lower areas 904 of the cookware formed inside and outside of the star shapes.

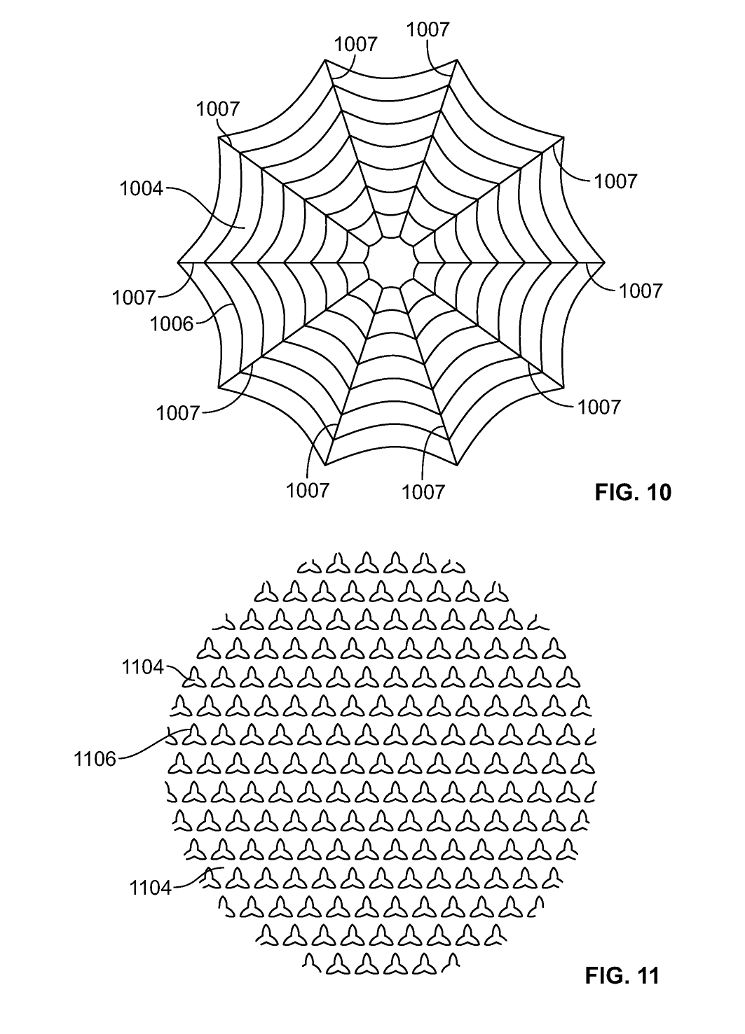

FIG. 10 depicts another exemplary embodiment of a cookware surface. In this embodiment, the raised portions 1006 form a web shape on the upper surface of the cookware. The web shape, formed by the raised portions 1006, can be formed with ten seams 1007, which are also formed as raised portions. Similar to the embodiment shown in FIGS. 1a-1d, the raised portions 1006 and seams 1007 can have a hard anodized finish applied to their surfaces, and a non-stick coating can be applied to the lower areas 1004 of the pan formed in the areas in between the raised portions 1006, 1007 forming the web shape.

FIG. 11 depicts another exemplary embodiment of a cookware surface. In this embodiment, the raised portions 1106 form three pointed star-like shapes. Similar to the embodiment shown in FIGS. 1a-1d, the raised portions 1106 can have a hard anodized finish applied to their surfaces, and a non-stick coating can be applied to the lower areas 1104 of the cookware surface formed in the areas in between the raised portions 1106 forming the three pointed star-like shapes.

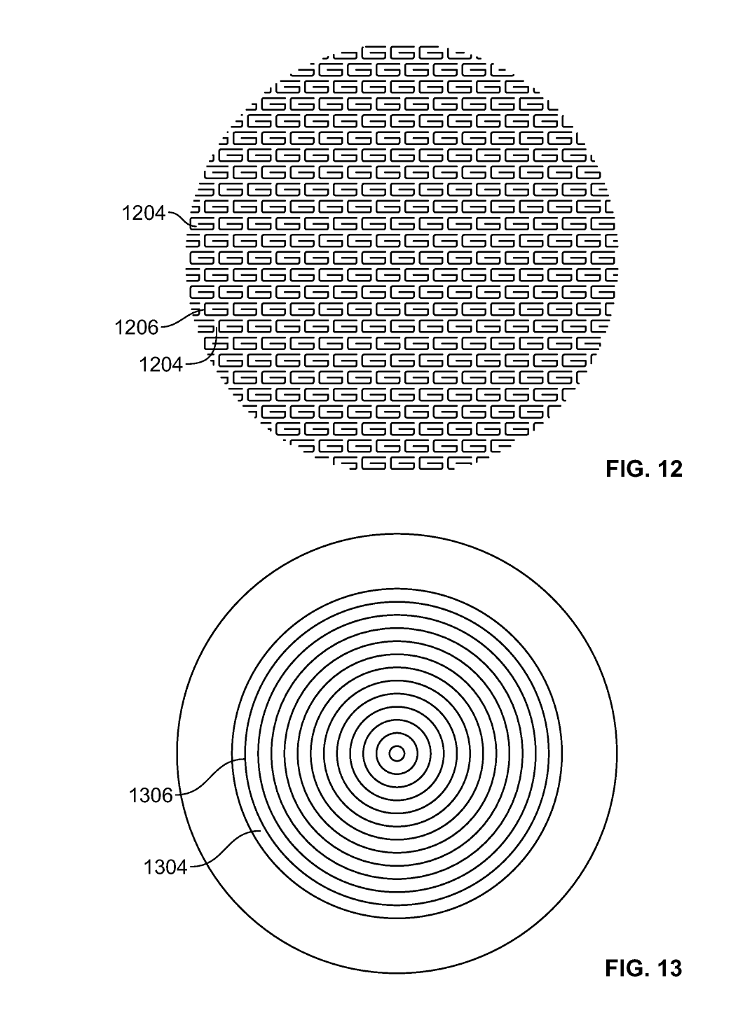

FIG. 12 depicts another exemplary embodiment of a cookware surface. In this embodiment, the raised portions 1206 can form shapes that are formed like the letter “G” or the number “6.” Similar to the embodiment shown in FIGS. 1a-1d, the raised portions 1206 can have a hard anodized finish applied to their surfaces, and a non-stick coating can be applied to the lower areas 1204 of the cookware formed inside and outside of the areas between the raised portions 1206 forming the shapes.

FIG. 13 depicts another exemplary embodiment of a cookware surface. In this embodiment, the raised portions 1306 can form concentric circles on the cookware surface. Similar to the embodiment shown in FIGS. 1a-1d, the raised portions 1306 can have a hard anodized finish applied to their surfaces, and a non-stick coating can be applied to the lower areas 1304 of the cookware surface formed between the concentric circles located on the cookware surface.

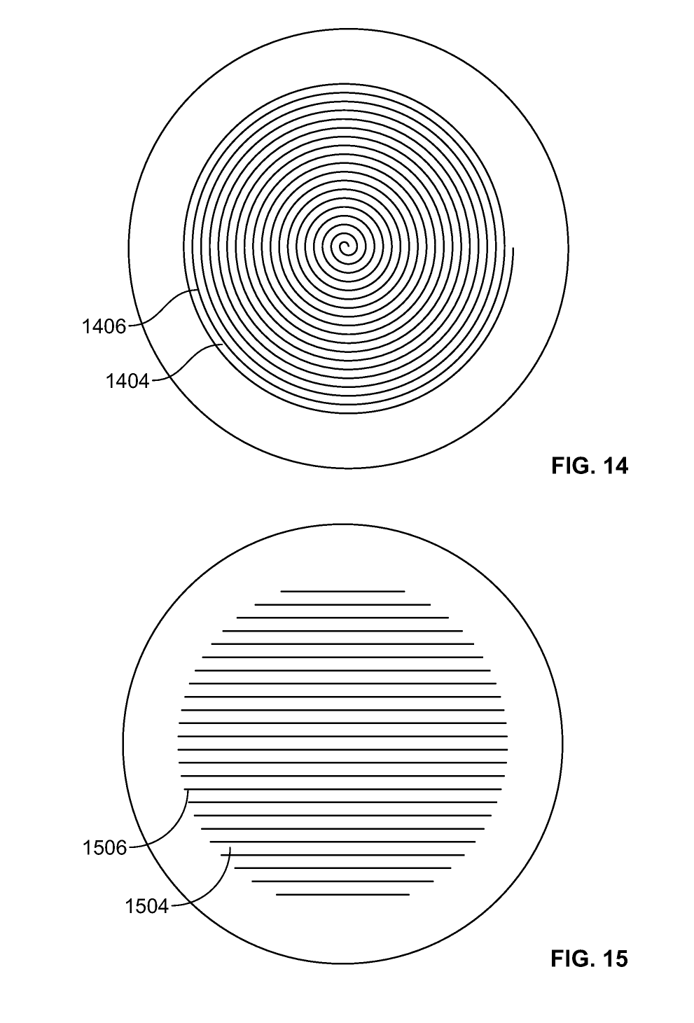

FIG. 14 depicts another exemplary embodiment of a cookware surface. In this embodiment, the raised portions 1406 can form a spiral shape on the cookware surface. Similar to the embodiment shown in FIGS. 1a-1d, the raised portions 1406 can have a hard anodized finish applied to their surfaces, and a non-stick coating can be applied to the lower areas 1404 of the cookware surface formed between the concentric circles located on the cookware surface.

FIG. 15 depicts another exemplary embodiment of a cookware surface. In this embodiment, the raised portions 1506 can form parallel lines on the cookware surface. Similar to the embodiment shown in FIGS. 1a-1d, the raised portions 1506 can have a hard anodized finish applied to their surfaces, and a non-stick coating can be applied to the lower areas 1504 of the cookware surface formed between the concentric circles located on the cookware surface.

The surfaces described herein can be applied to all kinds of cookware, for example, frying pans, sauce pans, bake pans, grill pans, stock pots, etc. that require better protection against scratches of cooking utensils while maintaining non-stick performance.

Aspects of the invention have been described in terms of illustrative embodiments thereof. Numerous other embodiments, modifications and variations within the scope and spirit of the disclosed invention will occur to persons of ordinary skill in the art from a review of this entire disclosure. For example, one of ordinary skill in the art will appreciate that the steps illustrated in the illustrative figures may be performed in other than the recited order, and that one or more steps illustrated may be optional in accordance with aspects of the disclosure.

1. A cookware surface comprising:
a corrugated surface, the corrugated surface having a plurality of raised portions and a plurality of lower areas;
wherein the lower areas have a non-stick surface formed thereon; and
wherein the raised portions have an anodized finish formed thereon.

2. The cookware of claim 1 wherein the raised portions are formed flat.

3. The cookware of claim 1 wherein the lower areas are formed flat.

4. The cookware of claim 1 wherein the lower areas form a larger surface area on the cookware surface than that of the raised portions.

5. The cookware of claim 4 wherein the raised portions comprise less than 20% of the cookware surface including the plurality of raised portions and the plurality of lower areas.

6. The cookware of claim 1 wherein the raised portions aid in preventing cooking utensils from rubbing off the non-stick surface of the lower areas.

7. The cookware of claim 6 wherein the raised portions provide adequate spacing to aid in preventing the cooking utensils from contacting the lower areas having the non-stick surface.

8. The cookware surface of claim 1 wherein the plurality of raised portions each define a surface and wherein each surface is free from non-stick material.

9. A method of forming a surface for cookware comprising:
forging a predetermined pattern of corrugations each defining a raised portion on a surface of the cookware and wherein areas between the corrugations define a plurality of lower areas on the surface;
applying a non-stick coating to the surface of the cookware;
removing the non-stick coating from each raised portions.

10. The method of claim 9 wherein the non-stick coating is removed from a surface of each raised portion by grinding the surface of the cookware.

11. The method of claim 9 wherein a surface of each raised portion is anodized to form an anodized finish on each of the raised portions.

12. The method of claim 10 wherein the surface of each the raised portion is grinded flat.

13. The method of claim 9 wherein the lower areas on the surface are formed flat.

14. The method of claim 9 wherein the lower areas together form a larger surface area on the surface than that of the raised portions.

15. The method of claim 14 wherein each of the raised portions together comprise less than 20% of the surface of the cookware including each of the raised portions and the plurality of lower areas.

16. The method of claim 9 wherein each of the raised portions together aid in preventing the cooking utensils from rubbing off the non-stick surface of the lower areas.

17. The method of claim 9 wherein the raised portions are spaced to aid in preventing cooking utensils from contacting the lower areas.
